(19) United States
(12) Patent Application Publication
(10) Pub. No.: US 2004/0059619 A1
(43) Pub. Date: Mar. 25, 2004

(54) Techniques for facilitating innovation-focused improvement of an entity

(76) Inventors: Daniel I. Swedberg, Haymarket, VA (US); Judith B. Douglas, Annandale, VA (US); Benjamin David Goldberg, Alexandria, VA (US); Basil N. Poulos, Oakton, VA (US)

Correspondence Address: David G. Wille, Esq., Baker & Botts, L.L.P., Suite 600, 2001 Ross Avenue, Dallas, TX, 75201-2980, US

(21) Appl. No.: 10/601,342

(22) Filed: Jun. 20, 2003

Related U.S. Application Data
(60) Provisional application No. 60/413,797, filed on Sep. 25, 2002.

(51) Int. Cl. G06F 17/60

(52) U.S. Cl. 705/8

(57) ABSTRACT

A method involves: assessing an innovation status of an entity; identifying at least one initiative with an innovation focus which is structured to increase the value of the entity; implementing the initiative; and repeating the assessing, identifying and implementing.

This application claims the priority under 35 U.S.C. §119 of provisional application No. 60/413,797 filed Sep. 25, 2002.

### STATEMENT REGARDING COPYRIGHT RIGHTS

A portion of this patent disclosure is material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

This invention relates in general to techniques for helping businesses and other entities adapt to changes and, more particularly, to techniques for helping entities adapt to changes that relate to the use of information-based technology and related opportunities.

### BACKGROUND OF THE INVENTION

The pace of information technology innovation and its potential for competitive disruption has increased significantly for businesses and other entities since the Internet became prominent less than a decade ago. Before that, information technology was one of a number of change drivers considered equally in assessing the future direction of a business enterprise and the changes required to get there. Structured strategic management methodologies involving the top-down analysis and development of future vision, articulation of goals and objectives, and development of programs and budgets provided an effective way to manage that change.

Since the Internet became prominent, however, information technology has become the most significant driver of change in business and other entities. While other change drivers are important and, in some cases, have a more immediate impact on the viability of business entities in some industries, the strategic requirement for businesses to effectively manage change associated with information technology innovation is paramount. Old methodologies for directing and managing that change are no longer adequate in most situations. In this regard, methodologies in place before the prominence of the Internet view information technology as merely an enabler of business, and merely attempt to “align” the technology platform to a business direction defined without adequate consideration for new business opportunities driven by information technology.

As the Internet became prominent, e-business strategy methodologies were developed for directing change. These methodologies addressed the need to adequately consider new business opportunities driven by information technologies, but did so by creating new standalone business ventures that provided little value for changing the overall business entity. In addition, those methodologies provided value for directing change, but not for the ongoing challenge of managing change over time. Consequently, while pre-existing techniques and methodologies have been generally adequate for their intended purposes, they have not been entirely satisfactory in all respects.

### SUMMARY OF THE INVENTION

From the foregoing, it may be appreciated that a need has arisen for a technique that effectively directs change within an organization to accommodate and take strategic advantage of information technology innovation. One form of the present invention involves: assessing the innovation status of an entity; identifying at least one initiative with an innovation focus which is structured to increase the value of the entity; implementing the initiative; and repeating the assessing, identifying and implementing.

### BRIEF DESCRIPTION OF THE DRAWINGS

A better understanding of the present invention will be realized from the detailed description which follows, taken in conjunction with the accompanying drawings, in which:

FIG. 1 is a block diagram showing a business relationship to which techniques embodying the invention can be applied, including a business enterprise, a client of the enterprise, and customers of the client;

FIG. 2 is a high-level flowchart showing a sequence which encompasses an innovation-focused continuous improvement process that embodies aspects of the present invention;

FIG. 3 is a diagram showing one annual cycle of the process of FIG. 2 in the context of a multi-year relationship between the enterprise and client of FIG. 1;

FIG. 4 is a diagram generated as part of the process depicted in FIGS. 2 and 3;

FIG. 5 is a chart showing a hypothetical example of a performance baselining technique;

FIG. 6 is a diagram of a maturity map utilized in the process of FIGS. 2 and 3;

FIG. 7 is a diagram similar to FIG. 6, showing a modified version of the maturity map; and

FIG. 8 is a chart which is equivalent to the chart of FIG. 5, except that it has an added column setting forth performance goals.

### DETAILED DESCRIPTION

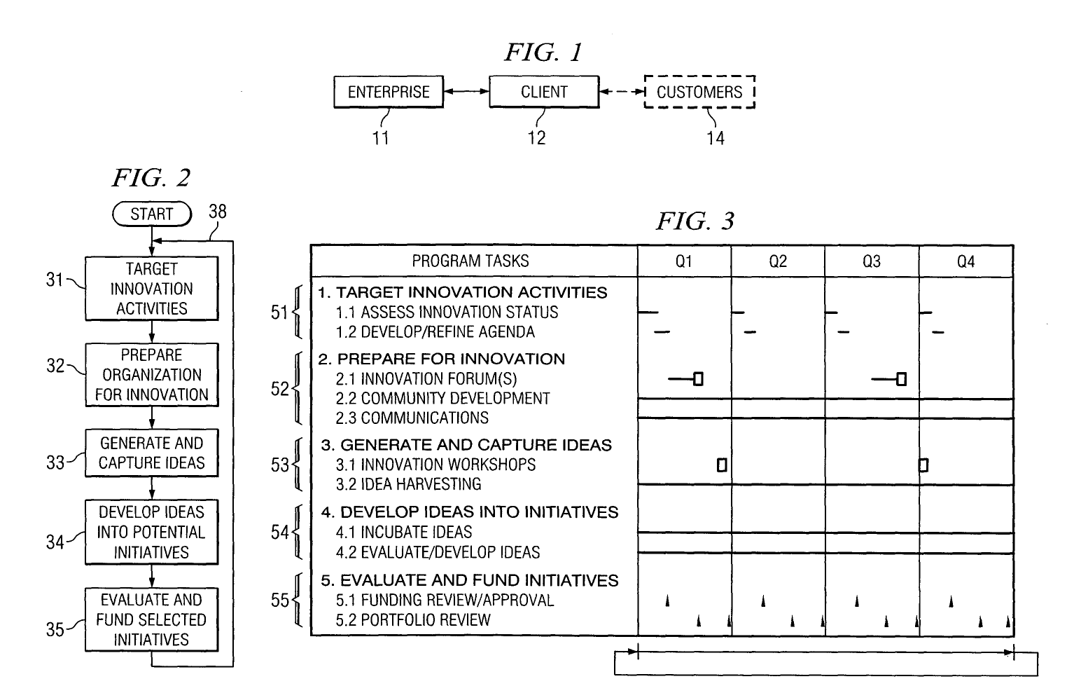

FIG. 1 is a block diagram showing a business enterprise 11 which has a client 12. Optionally, the client 12 may in turn have its own customers 14. The enterprise 11 provides offerings to the client 12, for example in the form of products and/or services.

For purposes of the following discussion, it is assumed that the enterprise 11 is an information technology (IT) provider, which supplies IT services and/or products to the client 12. However, the enterprise 11 could alternatively be any of a variety of other types of entities. In FIG. 1, the client 12 is a business enterprise. However, the client 12 could alternatively be some other type of entity, such as a government agency. Even if the client 12 was a government agency, it would typically still have customers 14 who are served by it. For example, a state or city would typically provide its residents or customers with police services, firefighting services, clean water, sewage disposal services, and waste disposal services.

It is beneficial for both the enterprise 11 and the client 12 if their business relationship grows over time, especially in regard to the fact that the world economy is progressively becoming a more information-based “digital economy”, as evidenced by the progressively increasing use of the Internet throughout the business world. One important stimulus for business growth is innovation, and a feature of the present invention is the provision of a technique which provides a continuous improvement process that is innovation focused. Although these techniques can be advantageous when applied in the context of a single entity such as either the enterprise 11 or the client 12, they are also advantageous when applied in a context that involves collaboration of two different entities.

For example, if the enterprise 11 and client 12 have entered into a contract under which the enterprise 11 will provide IT services to the client 12 over a time period such as five to ten years, utilization of techniques according to the invention will facilitate innovation-focused growth that is beneficial for both the enterprise 11 and the client 12. One benefit is that these techniques will help to reduce or avoid, during the later years of the contract, a lack of growth and a lack of innovation on the part of the enterprise 11 which could lead to dissatisfaction of the client 12.

FIG. 2 is a high-level flowchart showing a basic sequence which is involved in the innovation-focused continuous improvement process and which embodies aspects of the invention. The five stages shown in FIG. 2 are each discussed in more detail later, but are briefly addressed here. The first, which is shown in block 31, is to target innovation activities. The second, which is shown in block 32, is to prepare the organization for innovation. In a situation where two or more entities are collaborating, such as the enterprise 11 and client 12 of FIG. 1, preparation of the organization for innovation means preparation of each entity which is involved in the collaboration.

The third stage, which is set forth in block 33, is to generate and capture ideas regarding how innovation might be utilized to realize improvements. The fourth stage, which is set forth in block 34, is to develop some or all of the ideas into potential initiatives, at least some of which would be implemented in order to put selected ideas into practice. The fifth stage, which is shown in block 35, is to evaluate the initiatives and then fund at least some selected initiatives. The funded initiatives would actually be implemented, in order to foster innovation-focused improvement.

The arrow at 38 emphasizes that the process shown in FIG. 2 is a continuous process. In fact, it is not absolutely necessary to complete the entire sequence before starting it over again. Further, the sequence does not always have to be restarted from the very beginning, but could be restarted from some point partway through the loop, for example between blocks 31 and 32. Consequently, in an actual implementation, two or more iterations of the loop of FIG. 1 may overlap, and activities from two or more of the blocks 31-35 may be occurring simultaneously.

In this regard, FIG. 3 is a diagram showing how activities from each of the five blocks 31-35 of FIG. 2 would be carried out during any single year of a multi-year contract between the enterprise 11 and the client 12 of FIG. 1. It will be noted that the labels from the five blocks 31-35 in FIG. 2 each appear at the left side of FIG. 3. In particular, the five sections 51-55 of FIG. 3 respectively correspond to the five blocks 31-35 of FIG. 2.

With reference to section 51 of FIG. 3, a starting point for the disclosed process is to target innovation activities. This involves development of a program plan. The program plan is based on an assessment of innovation status, and is developed primarily on an annual basis, but with quarterly reviews in order to accommodate changing conditions and actual progress.

More specifically, at the beginning of each quarter, an effort is carried out to assess innovation status. In the disclosed approach, three assessment activities are performed in order to provide information needed to appropriately target innovation activities. These three activities are each discussed below, but it should be understood that it would alternatively be possible to use any of a variety of other assessment activities.

The first assessment activity is to carry out an innovation readiness assessment in order to identify client innovation opportunities and potential barriers. In the disclosed embodiment, this involves having 10 to 20 persons complete a network-based survey, where some of these persons are affiliated with the enterprise 11, and some are affiliated with the client 12. The survey includes a list of questions that are intended to assess innovation-related factors. TABLE 1 sets forth an excerpt from such a survey, showing a sample of 12 questions or criteria that are separately evaluated.

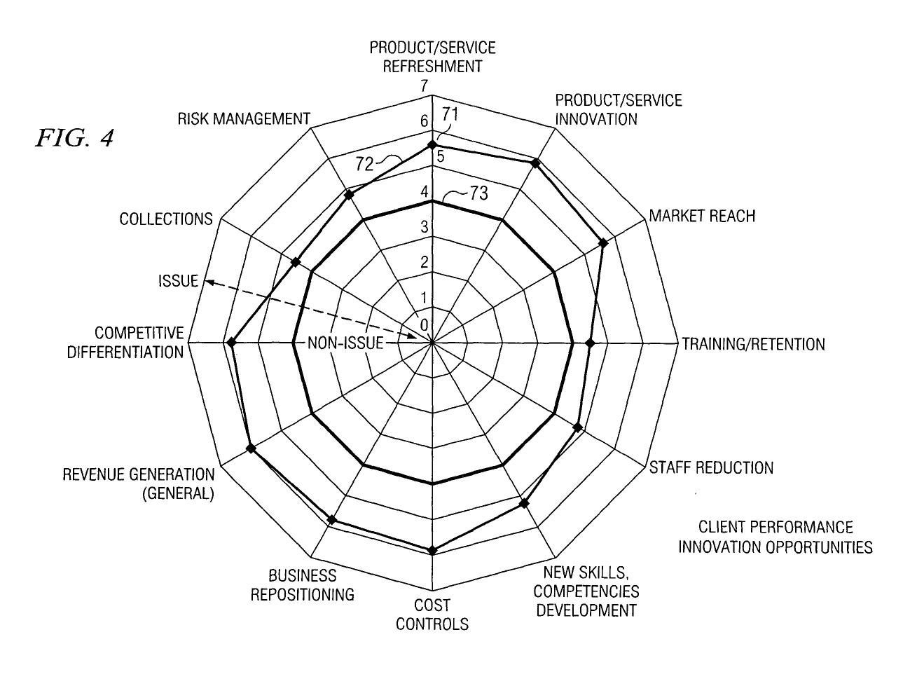

In particular, each person would evaluate each criteria by assigning it an integer value from 0 to 7, where 0 indicates that the criteria is not perceived as a significant issue, and 7 indicates that the criteria is perceived as a significant issue. For each criteria, the answers from all persons participating in the survey are averaged, and can then be displayed graphically. In this regard, FIG. 4 is a diagram of a type commonly known as a “spider” diagram, because it has an appearance reminiscent of a spider's web. This diagram has a plurality of radial spokes, and a plurality of concentric regular polygons. Each polygon represents a respective integer value from 1 to 7. Beginning at the top of the diagram, and working in a clockwise direction, each of the 12 radial spokes corresponds to a respective one of the 12 criteria set forth in TABLE 1, and a single point is plotted along each spoke to represent the average value calculated for the corresponding criteria.

For example, point 71 represents an example of an average value for criteria “A” in TABLE 1. The 12 plotted points which represent respective average values have a continuous line 72 drawn through them, in order to facilitate readability. The polygon 73 corresponds to a value of 4 and represents a middle or neutral value on the scale of 0 to 7, and is shown as a bold line in FIG. 4 in order to make it easy to see where the line 72 is disposed inwardly and/or outwardly of the neutral polygon 73. A more detailed example of a technique for assessing innovation readiness, including a survey, is provided in U.S. Ser. No. 10/412,662 filed Apr. 11, 2003, the disclosure of which is hereby incorporated herein by reference.

TABLE 1
The entity's critical business performance issues
lie in the area (s) of:

| | |
|---|---|
| A. | Product/service refreshment |
| B. | Product/service innovation |
| C. | Market reach |
| D. | Training and retaining staff |
| E. | Reducing staff |
| F. | Acquiring new skill sets, competencies |
| G. | Cost controls |
| H. | Business positioning |
| I. | Revenue generation in general |
| J. | Competitive differentiation |
| K. | Collections |
| L. | Risk management |

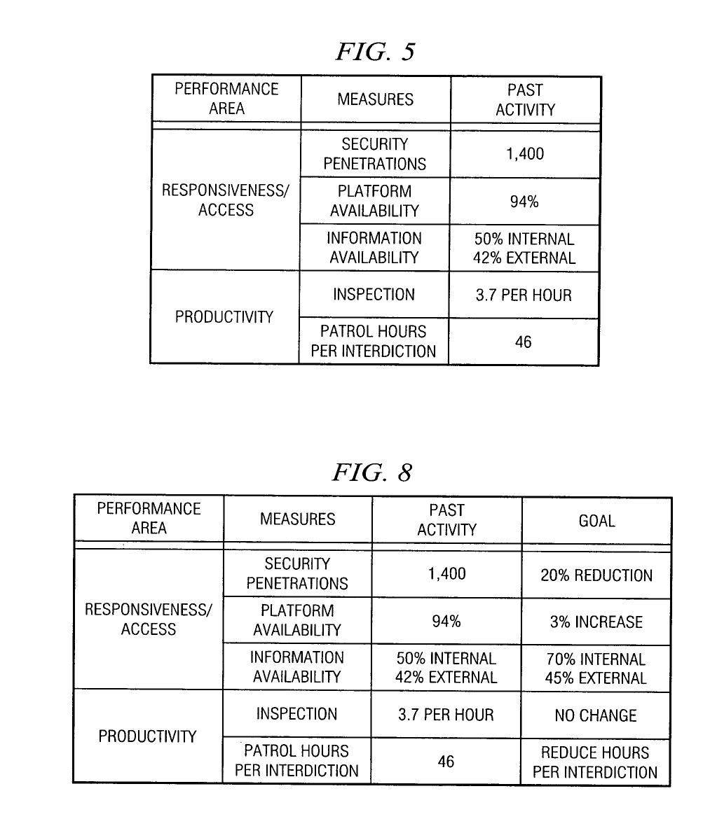

A second assessment activity used to assess innovation status is to effect performance baselining. FIG. 5 is an example of a chart used for performance baselining. The chart identifies one or more factors which have been selected to measure performance in each of several corresponding performance areas, and also summarizes past activity for each specified factor. In FIG. 5, the “Past Activity” column represents activity during the one-year period preceding the performance baselining analysis.

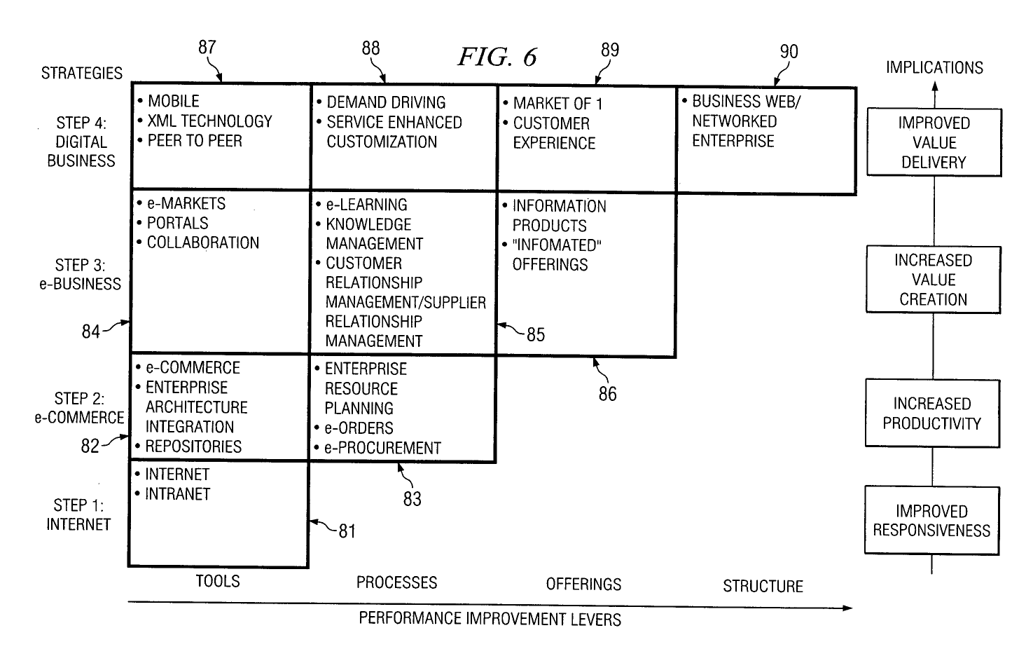

The third assessment activity used to assess innovation status is to evaluate the level of maturity of the client 12 with respect to various factors that tend to relate to success in a digital economy. In this regard, FIG. 6 is a diagram which can be referred to as a maturity map, and which has ten blocks 81-90 that each represent a different aspect of factors relevant to success in a digital economy. A separate analysis is performed in association with each of these ten blocks, in order to determine for each block the level of maturity of the client with respect to the factors associated with that block.

More specifically, the block 81 involves an evaluation of whether the core infrastructure is in place for digital economy innovation. This involves analysis of considerations such as whether the client has an Internet Web site, whether the client has an intranet, and whether basic information about the client is available through the Internet, such as information about products and services, business locations, administrative information, organizational information, and directory information.

Block 82 involves an evaluation of whether the core tools are in place for processing transactions over the Internet and/or an intranet. This involves analysis of factors such as whether Internet transaction processing technologies of the type commonly known as e-commerce are used, whether those technologies have been integrated backwards into legacy systems, and whether the client has moved to dynamic repositories (as opposed to static Web pages) in order to drive information to the Internet or intranet.

Block 83 involves an evaluation of whether employees, partners, customers or others can conduct transactions with the client over the Internet or an intranet. This involves factors such as whether back-end administrative processes have been configured in a manner which will support e-commerce, whether customers can place orders and compute the status of orders, and whether suppliers can transact business with the client over the Internet.

Block 84 involves an evaluation of whether enabling technologies are in place to embed knowledge in the client's business processes. This involves evaluation of factors such as whether collaboration tools are available to support the sharing of knowledge internally and/or with customers or partners, whether the Internet site has evolved so as to support personalization through portal technologies, and whether dynamic pricing technologies of the type referred to as e-markets are used.

Block 85 involves an evaluation of whether key applications are in place to capture, retrieve and/or share knowledge. This involves evaluation of factors such as whether there is a robust e-learning capability in use, whether there are formal mechanisms for sharing knowledge, and whether there is an ability to obtain a single view of customers and/or suppliers through customer or supplier relationship management applications.

Block 86 involves an evaluation of whether mechanisms have been established to exploit knowledge beyond solving of single problems. This involves evaluation of factors such as whether there are formal communities of practice (CoPs) for exploiting practice knowledge, whether customer data is mined in order to better personalize service, and whether knowledge has been driven to patents and new product offerings.

Block 87 involves an evaluation of whether enabling technologies are used to collaborate at the extra-entraprise level. This involves evaluation of factors such as whether mobile technologies are used to communicate beyond individuals, whether legacy applications are Internet-enabled through the use of extensible Mark-up Language (XML) technologies, and whether peer-to-peer technologies have been deployed to support ad-hoc communication requirements.

Block 88 involves an evaluation of whether the enterprise has established processes to enhance services through personalization and/or customization. This involves evaluation of factors such as whether customers can dictate service requirements like delivery and/or payment terms, and whether operational processes have been re-engineered in order to dynamically respond to demand signals.

Block 89 involves an evaluation of whether the enterprise has shifted from a solution to an experience focus for its offerings. This involves evaluation of factors such as whether product, service and information elements of offerings are all leveraged in providing value, and whether customers can design and/or configure their own products.

Block 90 involves an evaluation of whether the organization has a defined strategy for alliance and/or partnering. This involves evaluation of factors such as whether there has been a shift in focus to core competencies, and whether alliances involve a sharing of risk and/or return.

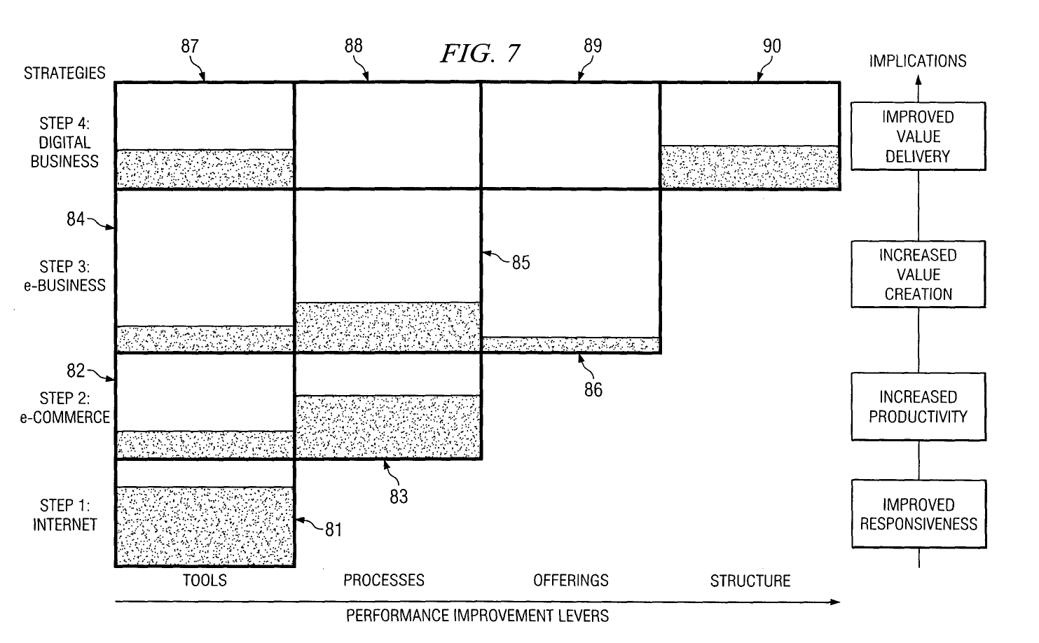

As each of the blocks 81-90 in FIG. 6 is evaluated, a maturity level ranging from 0% to 100% is determined for that block. The maturity level assigned to each block can then be displayed graphically. For example, FIG. 7 is a diagram similar to FIG. 6, except that the criteria listed in each of the blocks 81-90 has been omitted, and each of the blocks 81-90 instead includes a degree of shading which corresponds to the percentage of maturity assigned to that block. It will be noted that blocks 88 and 89 were each assigned a maturity level of 0%, and thus have no shading. Block 85 was assigned a maturity level of approximately 50%, so approximately half of block 85 is shaded. Block 81 was assigned a maturity level of approximately 75%, and thus about three-quarters of block 81 is shaded.

The foregoing discussion has been directed to the three assessment activities that are utilized for the task of assessing innovation status at 51 in FIG. 3. This assessment of innovation status is carried out primarily at the beginning of each annual cycle, but is also carried out on a secondary level at the beginning of each quarter.

Then, after innovation status is assessed in each quarter, a subtask of developing and/or refining an agenda is carried out. The basic purpose of this subtask is to utilize the results of the innovation status assessment to define some performance targets or goals. Typically, these targets or goals would be established once each year, with adjustment or refinement on a quarterly basis. As an example, FIG. 8 is a chart in which the left three columns are identical to the chart in FIG. 5. The right column in FIG. 8 is a new column, which sets forth some performance goals for the coming year, defined in relation to the past activities set forth in the adjacent column.

Referring to section 52 in FIG. 3, a further task is to prepare the participating entity or entities for innovation. The fundamental purpose of this effort is to build awareness of innovation among all persons associated with the process, and to stimulate ideas that can result in innovative activities. In the disclosed embodiment, this is effected through three different subtasks.

The first subtask is to conduct innovation forums, for example in the form of a one-day innovation forum or seminar every six months. Each such forum will endeavor to communicate certain useful information to relevant persons from each of the enterprise 11 and client 12, including the latest trends in technology and the use of technology for business value. The specific topics will, of course, depend on the latest trends, and may also be influenced by the annual plan established at 51 in FIG. 3. The forums will typically involve both presentations and panel discussions, which are intended to link general trends to specific issues of the client 12.

A second subtask of the section 52 is community development, where the term “community” refers to a group of persons within the enterprise 11 and client 12 who are in a position to make positive contributions to the overall process. In a sense, the community is a virtual network which links these persons, which provides access to a virtual repository of useful information and collaboration capabilities, and which may also involve routine virtual meetings to develop and maintain the innovation community.

The third subtask carried out in section 52 will involve communications or feedback. In this regard, a broadcast communications effort will be maintained in order to communicate certain information to relevant persons within each of the enterprise 11 and client 12, including the status of innovation activities, as well as success stories and other information of interest. Innovation awareness events will be held to facilitate distribution of knowledge. One example of an innovation event would be a booth or table set up in an on-site cafeteria every six months in order to disseminate information to persons who come to the cafeteria to eat. Ultimately, the communications subtask is intended to build awareness, through both proactive and reactive activity.

Section 53 of FIG. 3 relates to the third task, which is to generate innovation ideas. This is effected using two different subtasks. First, a two-day innovation workshop is conducted every six months. Selected persons from each of the enterprise 11 and client 12 will attend the workshop, and will engage in some organized brainstorming with the goal of identifying approximately five to seven ideas that each have an innovation focus and that each have the potential to result in improvements. A more detailed example of such a workshop is provided in U.S. Ser. No. 10/255,771 filed Sep. 25, 2002, the disclosure of which is hereby incorporated herein by reference

A second subtask carried out at 53 in FIG. 3 is to maintain an idea harvesting process. In the disclosed embodiment, this includes implementation of an Internet Web site that provides guidance on issues which the collaborative effort is trying to resolve, along with a structured process for defining potential ideas. In a sense, this Internet Web site serves as a form of virtual suggestion box.

Section 54 in FIG. 3 takes the ideas which were generated in section 53, and develops these ideas into initiatives. This involves two subtasks. The first subtask is to incubate the ideas in order to further explore each idea and the possible variations of it. The second subtask is to evaluate and develop each idea. In essence, a business case is developed for implementing each idea through a respective innovation initiative. The business case defines costs, benefits and risks associated with the initiatives.

Section 55 in FIG. 3 involves evaluation and funding of initiatives developed at section 54. In the disclosed embodiment, this involves two subtasks. The first subtask is to review the various initiatives which have been developed, and then select and fund the initiatives which are believed to have the strongest potential for achieving improvements. Meetings to review, select and fund initiatives are held quarterly. The initiatives which are selected and funded are actually implemented, so that they have a real-world effect that tends to promote innovation-focused improvement.

The second subtask at 55 involves monthly meetings for the purposes of reviewing the “portfolio” of initiatives that are currently in the process of being implemented. At any given point in time, the portfolio of active initiatives may involve a number of ongoing initiatives which were started at various different times in the past. Based on the portfolio review meetings, the structure or configuration of some initiatives may be fine tuned in order to increase their effectiveness.

The present invention provides a number of advantages. One such advantage results from the provision of an innovation-focused improvement process which is effectively continuous. This is advantageous in contexts such as an ongoing contractual relationship between two entities, because it reduces or avoids dissatisfaction by one or more of these entities during the later years of the contract as a result of a lack of utilization of innovation. The invention helps entities identify opportunities to use existing and new information technology to increase value. A further advantage is the provision of a well-defined technique for responding in a controlled manner to concerns and opportunities caused by rapid information technology innovation.

The invention provides a vehicle for changing existing businesses or other entities with an eye toward defining and implementing change by those who are directly affected by change, in order to speed the realization of benefits and reduce implementation cycle time. In a sense, this approach represents an organic change to the entity. A further advantage is the provision of an incentive for existing information technology innovators and business problem experts to collaborate in creating and implementing ideas to leverage information technology for business enterprise performance improvements. It facilities collaboration in solving problems of the entity, or otherwise improving the value of the entity.

Although one embodiment has been illustrated and described in detail, it will be understood that various substitutions and alterations are possible without departing from the spirit and scope of the present invention, as defined by the following claims.

What is claimed is:

1. A method, comprising:
assessing an innovation status of an entity;
identifying at least one initiative with an innovation focus which is structured to increase the value of said entity;
implementing said initiative; and
repeating said assessing, identifying and implementing.

2. A method according to claim 1, including a further entity, and causing said entities to participate collaboratively in carrying out each of said assessing, identifying and implementing.

3. A method according to claim 1,
wherein said identifying includes: developing a set of initiatives, evaluating costs and benefits of each of said initiative in said set, and allocating funding to a subset of said initiatives in said set; and
wherein said implementing is carried out for each said initiative in said subset.

4. A method according to claim 1, wherein said assessing includes having a plurality of persons each complete a survey which assesses a status of said entity with respect to each of a plurality of innovation-related factors.

5. A method according to claim 1, wherein said assessing includes evaluating current performance of said entity with respect to each of a plurality of selected factors.

6. A method according to claim 1, wherein said assessing includes evaluating a level of maturity of said entity with respect to each of a plurality of digital economy factors.

7. A method according to claim 1, wherein said assessing includes:
evaluating said entity with respect to each of a plurality of selected factors; and
establishing an improvement goal for each of a plurality of said factors.

8. A method according to claim 1, wherein said identifying includes building awareness of innovation within said entity.

9. A method according to claim 8, wherein said building includes offering periodic presentations which each relate to recent developments in digital technology.

10. A method according to claim 8, wherein said building includes establishing a virtual community structured to foster innovation.

11. A method according to claim 8, wherein said building includes feeding back information relating to said assessing, identifying and implementing.

12. A method according to claim 1, wherein said identifying includes generating ideas that represent potential said initiatives.

13. A method according to claim 12, wherein said generating includes holding periodic workshops which each involve a plurality of persons and which are each structured to generate a plurality of said ideas.

14. A method according to claim 12, wherein said generating includes establishing a virtual site which continuously provides information about selected issues and can accept input representing said ideas.

15. A method according to claim 12, wherein said identifying includes developing each of a plurality of said ideas into potential initiatives.

16. A method according to claim 15, wherein said identifying includes:
evaluating costs and benefits for each of said potential initiatives; and
allocating funding to at least one of said potential initiatives, said implementing being carried out for each said initiative which is funded.

17. A method according to claim 16, including holding periodic meetings to review and refine said implementing of each said funded initiative.
